(19) United States
(12) Patent Application Publication
(10) Pub. No.: US 2011/0163116 A1
(43) Pub. Date: Jul. 7, 2011

(54) Bottled water dispenser

(76) Inventor: Charles Dixon, Bonsall, CA (US)

(21) Appl. No.: 12/930,335

(22) Filed: Jan. 3, 2011

Related U.S. Application Data
(63) Continuation-in-part of application No. 11/777,964, filed on Jul. 13, 2007, now abandoned.
(60) Provisional application No. 60/831,058, filed on Jul. 14, 2006.

(51) Int. Cl. B67D 7/84; B65D 88/54

(52) U.S. Cl. 222/1; 222/333; 222/481; 222/146.1; 222/164

(57) ABSTRACT

Embodiments of an improved bottled water dispenser are loadable from beneath and may include a movable cart which is used to position the water bottle in the bottled water dispenser. The moveable cart may be angled to facilitate removal of water from the bottle, as well as to facilitate loading of bottle onto movable cart. The movable cart may include a retaining feature and a drawbridge to facilitate loading of the bottle onto the platform. In other embodiments the water dispenser includes a funnel member positioned at the top of the bottle, and a rod member which is movable to engage the funnel member, placing a pump in fluid communication with the water.

### CROSS-REFERENCE TO RELATED APPLICATIONS

This application claims priority under 35 U.S.C. 119 (e) to U.S. Provisional Application No. 60/831,058 filed Jul. 14, 2006.

This application is a request for Continuation in Part of U.S. Non-Provisional application Ser. No. 11/777,964

### FIELD OF THE INVENTION

Embodiments of the present invention generally related to improved fluid dispensers.

### DESCRIPTION OF THE RELATED ART

Current bottled water dispensers comprise certain undesirable features. Most notably, the vast majority of bottled water dispensers require that a full bottle of water be lifted well off the ground, inverted, and placed on the bottled water dispenser. Such designs limit the number of potential users of bottled water dispensers, as many potential customers are unwilling or physically unable to lift and maneuver heavy bottles full of water. The need for an alternate means for loading a water dispenser exists among women, elderly people, and people who are physically handicapped. Even among users who are physically capable of using such dispensers, there is a significant risk of injury during this loading process. An additional undesirable feature of current bottled water dispenser design is the aesthetics of the current design. Most current water bottle dispensers have the bottle contained in a visible position and the bottle is maintained in an inverted position on the exterior of a water dispenser. This can create an aesthetic problem for people who may find the bottles or the dispensers unsightly. Additionally, as current bottled water dispenser design includes the necessity of inverting the bottle on top of the bottled water dispenser, the opening of the bottle and the neck of the bottle will become submerged or partially submerged in the water of the dispenser. Unless precautions are used and the exterior of the bottle cleaned off appropriately, this is unsanitary and can contaminate the water. Lastly, current bottled water dispensers pose a potential hazard to small children and personal property in that the bottle of water is inverted on top of a dispenser and the dispenser, in the event of being bumped into or shaken, is not designed to sufficiently hold the inverted bottle in place. The bottle is at risk of falling and injuring a child or property in the area around the dispenser should this shaking or bumping of the dispenser occur as may be the case in the event of an earthquake or if a toddler tries to climb the unit.

Certain bottled water dispenser designs attempt to solve these problems by permitting the bottle to be loaded near or adjacent to the base of the bottled water dispenser, and permit the bottle to be oriented with the top facing upward, such that the bottle need not be inverted during the loading process. However, while these designs partially alleviate the difficulty and risks associated with loading the full bottles of water, they still require that the bottle be manually moved into position in or near the dispenser. Thus even these inverted bottle dispensers require a significant amount of strength and coordination to load full bottles.

### SUMMARY OF THE INVENTION

In one embodiment, an apparatus for dispensing fluid from a container is provided, the apparatus including a movable platform configured to support a container, the moveable platform including a platform surface, where the platform surface is configured to support the container such that the upper surface of fluid within the container is at an angle to the ground, two horizontal members connected to the platform surface via ratcheted hinges so they can be adjusted in a range from a narrow V shape to a wide V shape depending on the size of the container for the purpose of guiding the container on to the platform, a ramp member connected to an edge of the platform surface via a ratcheted hinge, the ramp member being rotatable about the hinge from a first position in which the edge of the ramp member is in contact with the ground, to a second position in which the edge of the ramp member is supported by either the platform surface or a container located on the platform, and a substantially vertical construct extending upward from the platform, a flexible member configured to extend around at least a portion of the container, and a gear box supported by the substantially vertical construct and operably connected to the flexible member, where the gear box is configured to pull the flexible member towards the gear box by either manual actuation or by power actuation. The substantially vertical construct is comprised of two substantially vertical members extending upward from the back of the platform surface and configured in such a manner that three substantially horizontal members connect the two substantially vertical members together at intervals extending upward from the platform surface for the purpose of providing structural stability. The gear box is supported by the middle horizontal member.

In another embodiment, an apparatus for dispensing fluid from a container is provided, the apparatus including a platform configured to support a container, such that an upper surface of fluid within the container is at an angle to the ground, a rod member, including a first lumen extending the length of the rod member, the lumen including a first end located at the distal end of the rod member, and a second end located at the proximal end of the rod member, and a second lumen including a first end located at an aperture in the side of the rod member near the distal end of the rod member, and a second end in fluid communication with a portion of the first lumen, a funnel member configured to be placed in an aperture located in an upper surface of a container, where the funnel member is configured to receive the distal end of the rod member, the funnel member including a hollow conical portion having an outer diameter at the widest point of the conical portion extending from the narrower end of the conical portion, the substantially cylindrical portion including a luminal area configured to receive a rod member, and a flexible tube in fluid communication with the luminal area of the substantially cylindrical portion, where the flexible tube is configured to reach substantially the lowest portion if the container.

In another embodiment, a method of preparing an apparatus to dispense fluid from a container is provided, the method including inserting a funnel member into an aperture in an upper surface of the container, the funnel member including a hollow conical portion, a substantially cylindrical portion extending from the narrow end of the conical portion, and a flexible tube extending from the substantially cylindrical portion toward the base of the container, securing a flexible member around at least a portion of the container, actuating a gear box to pull the flexible member toward the gear box, thereby pulling the container onto a moveable platform to which the gearbox which may be either manually actuated or actuated by power motor. The gear box and the flexible member are operably connected, the moveable platform including a ramp member extending downward at an angle from the edge of a platform surface, the platform surface configured to support the container such that an upper surface of fluid within the container is oriented at an angle to the ground to aide in loading the container onto the platform, and translating a rod member along the axis of the rod member to engage the distal end of the rod member with funnel member, such that the proximal end of the rod member is in fluid communication with the distal end of the flexible tube.

In another embodiment, a method of preparing an apparatus to dispense fluid from a container is provided, the method including inserting a funnel member including a hollow conical portion, a substantially cylindrical portion extending from the narrow end of the conical portion and including a lumen extending through the cylindrical portion, and a flexible tube extending from the substantially cylindrical portion toward the base of the container and in fluid communication with the lumen extending through the cylindrical portion, such that the proximal end of the rod member is in fluid communication with the distal end of the flexible tube.

In another embodiment, a method of positioning a container in preparation for dispensing fluid from the container is provided, the method including positioning a movable platform adjacent to the container, the movable platform including a ramp member extending from the edge of a platform surface, and rotatable with respect to the edge, positioning the ramp member such that the ramp member extends downward at an angle from the edge of the platform surface, securing a flexible member around at least a portion of the container, actuating a gear box to pull the flexible member toward the gear box, thereby pulling the container onto the platform surface of the moveable platform, where the platform surface supports the container such that an upper surface of fluid within the container is oriented at an angle to the ground to aide in loading the container onto the platform, and moving the movable platform to a position whereby fluid can be dispensed.

In another embodiment, an apparatus for dispensing fluid from a container is provided, the apparatus including means for positioning the container, where the positioning means are configured to support the container such that an upper surface of fluid is oriented at an angel to the ground, means for securing the container to the positioning means, means for loading the container onto the positioning means, where the loading means are configured to translate the securing means with respect to the positioning means thereby pulling the container onto the positioning means and means for dispensing fluid from the container, where the dispensing means simultaneously permit the influx of air into the container as fluid is dispensed.

In another embodiment, an apparatus for dispensing fluid from a container is provided, the apparatus including a means for storing and chilling fluid, said means for storing and chilling fluid including a container for chilled fluid, a float switch or other means for establishing fluid level in chilled fluid container, an aperture in the side of the chilled fluid holding tank for the purpose of dispensing fluid to the exterior of the apparatus, a means for recirculating the chilled liquid back through the entire dispensing apparatus for the purpose of maintain freshness of liquid, a refrigeration means, a relay switch for the purpose of actuating the temperature control of the refrigeration means, an aperture in the bottom of said chilled fluid holding tank for the purpose of dispensing fluid into a heated fluid holding tank, fluid connection to a pump for the purpose of pumping water to external devices, a concave area in the top of container of chilled fluid for the purpose of providing a refrigeration means for items to be held in cold storage. The possibility exists that this chilled fluid storage container which contains a concave feature in the top of said container can be actuated between cold or hot temperatures for the purpose of holding either heated items or chilled items in the top of fluid dispenser.

In another embodiment, an apparatus for dispensing fluid from a container is provided, the apparatus including a means for storing and heating fluid, said means for storing and heating fluid including a container for heated fluid, an aperture in the top of said holding tank for the purpose of receiving fluid from the chilled fluid holding tank, a float switch or other means for establishing fluid level in heated fluid container, a heating element for heating the liquid to be stored, a relay switch for the purpose of actuating the temperature control of the heating element, and a means for dispensing fluid out of the fluid dispensing mechanism held in the heated fluid holding container.

In another embodiment, an apparatus for dispensing fluid from a container is provided, said apparatus including a control box for the purpose of containing a potential combination of items and components including all or some of the following: electrical, electronic, and power elements; a pump for the purpose of moving liquid between various liquid holding containers, a/c power inlet to the dispensing apparatus for the purpose of providing power to the unit which is operably connected to a back-up battery supply, also operably connected to a change bottle indicator light, hot/cold water display, a timer for the purpose of activating the change bottle indicator light, a trickle charger for the purpose of providing additional charge to batteries from a/c conduit, a rectifier operably connected to battery and a/c power for the purpose of changing a/c power to d/c power in order for the pump to be able to activate.

### BRIEF DESCRIPTION OF THE DRAWINGS

FIG. 1 is a schematic cross-section of the interior of one embodiment of a fluid dispenser.

FIG. 2A is a schematic side view of an embodiment of a moveable cart for loading and positioning fluid containers.

FIG. 2B is the rear view of the moveable cart of FIG. 2A.

FIG. 3 is a schematic cross-section of embodiments of a funnel member and a rod member configured to engage the funnel member, for use in removing fluid from a container.

FIG. 4A is a side view of an embodiment of a fluid dispenser.

FIG. 4B is a rear view of the fluid dispenser of FIG. 4A.

### DETAILED DESCRIPTION OF THE PREFERRED EMBODIMENT

Embodiments of the present invention provide dispensers for bottles water or other fluids which address certain of the problems associated with existing bottled water dispensers. In particular, certain embodiments of the present invention provide a fluid dispensing system which does not require that the user have the strength of dexterity to lift a full bottle of water during the loading process.

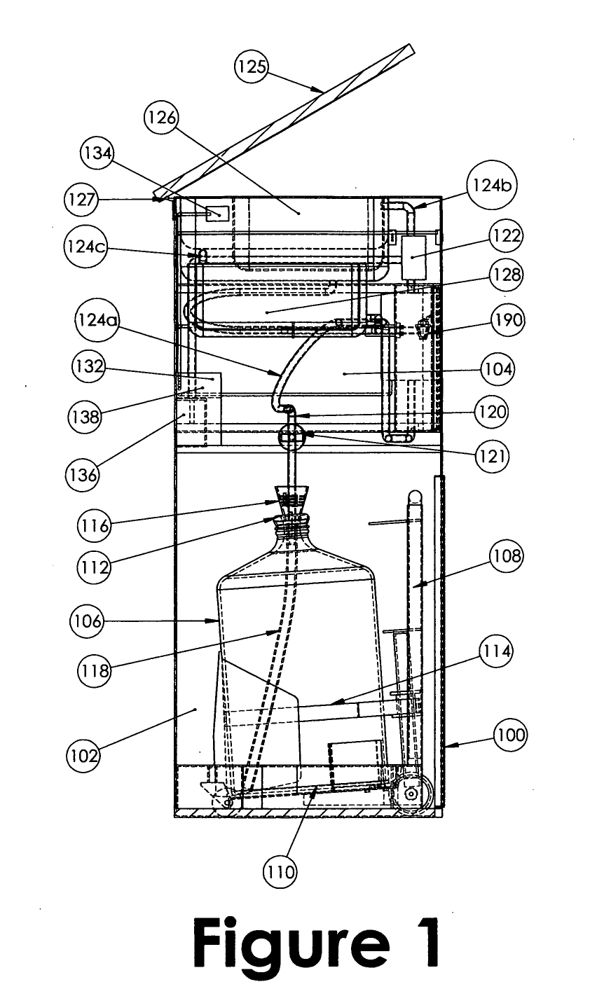

A first embodiment is described with respect to FIG. 1 which schematically illustrates a cross-sectional view of fluid dispenser 100. In the illustrated embodiment, the fluid dispenser 100 comprises a cabinet with a first chamber 102 located at the base of dispenser 100, which is at least large enough to hold bottle 106 or other appropriate fluid container. A second chamber 104 is located above the first chamber 102, and is configured to retain a variety of components which will be discussed in greater detail below. While the chambers 102 and 104 may be located in other positions relative to one another, the placement of the chamber 102 at the base of the dispenser advantageously permits the bottle 106 to be positioned within the chamber 102 without significant lifting of the bottle. In alternate embodiments, the second chamber 106 may be located to one side of the first chamber. Further it will be understood that chambers 102 and 104 need not be isolated from one another, but that a single chamber may contain both bottle and other components, which may be anchored to the interior walls of the chamber or supported by shelves extending across a portion of the chamber.

It can be seen in the illustrated embodiment that the bottle 106 is supported within the first chamber 102 by a moveable cart 108, which comprises a platform 110 on which the bottle 106 rests. Advantageously, as seen in the illustrated embodiment, the platform 110 is oriented at an angle to the ground such that when only a small amount of water remains in the bottle 106, the water that remains collects in a portion of the bottle located substantially underneath the opening 112 in the top of bottle 106. The platform 110 has affixed upon it vis ratcheted hinges 145a and 145b, two horizontal members, 143a and 143b which are moveable along their axis of the hinges from a parallel position in which no bottle will be able to be moved onto the cart, to a “V” position, which will enable guidance of the bottle 106 onto the platform 110 which helps in the guiding of the bottle 106 as well as the retention of bottle 106 in proper position for dispensing fluid from bottle 106. The horizontal members 143a and 143b are designed such that they can aid in guiding the movement of a variety bottle sizes onto platform 110. In addition, horizontal members 143a and 143b are removable. The cart 108 also contains a retention feature 114 extending around the bottle 106 configured to retain the bottle 106 in place. This retention feature 114 is a loop of flexible material which also has attached to it a strap of broader lateral dimensions which is affixed thereon to provide stability to the bottle when loop of flexible material is placed around bottle 106.

Near the top of the bottle 106, it can be seen that funnel member 116 has been positioned in the opening 112, and a tube member 118 extends from the lower portion of the funnel member 116 into the interior of the bottle 106. Although described here in as a funnel member, it will be herein understood that while the member may advantageously comprise a funnel-like tapering shape, a wide variety of shapes may be suitable and may be used in other embodiments. In order to minimize the amount of fluid left in the bottle, the tube member 118 advantageously extends to the base of bottle 106. Preferably it can extend to the most distant part of the base of the bottle. The tube member may comprise any suitable material or shape, and may even comprise, e.g., a pipe, although the tube member 118 is advantageously flexible or pliable and is configured to permit fluid flow between the bottle 106 and funnel member 116. A rod member 120 is actuatable along the axis of the rod member 120 between a first position where the rod member 120 engages the funnel member 116 and a second position where the rod member 120 no longer engages the funnel member 116, and wherein movement of the bottle 106 in or out of the first chamber 102 is not obstructed by the rod member 120. In one embodiment, the rod member 120 may extend through a fixed sleeve 121 in order to constrain movement of the rod member 120 in directions other than translation along the axis of rod member 120. This sleeve may comprise a variety of materials such as poly slide bushing or any material which has a desirably low coefficient of friction.

The rod member 120 is in fluid communication with a pump 122 via a tube 124a. As can be seen, tube 124a is of sufficient length to extend between pump 122 and the rod member 120 when the rod member 120 is actuated to its maximum distance away from pump 122. In a further embodiments (not shown), the tube 124a may comprise a coiled portion, so as to provide additional extension of the tube 124a when necessary (e.g., when the rod is engaged with the funnel member), and to retract the tube 124a when necessary, so as to avoid slack tubing interacting with other components. In another embodiment, a filter (not shown) may be provided along the fluid path from the bottle 106 to the fluid outlet. In one embodiment, the filter may be an in-line filter.

In the illustrated embodiment, the pump 122 is further in fluid communication with a cold water reservoir 126 via tube 124b. Cold water reservoir 126 may comprise a container having cooling elements located either within the container or around the container, such that water or other fluid located within the cold water reservoir can be cooled to a desirable temperature. The cold water reservoir may further comprise a sensor which is configured to detect the current temperature of the fluid within the cold water reservoir and adjust the cooling of the water appropriately. Top of cold water reservoir 126 is has a large concave portion which is externally accessible via lid 125 which is connected to fluid container 100 via a ratcheted hinge which enables the lid 125 to be moved between a closed position in which the lid 125 is being supported by the top of fluid dispenser 100 and an upright position wherein the lid 125 is supported by a ratchet in the hinge allowing access to concave space in cold water reservoir 126.

In the illustrated embodiment, a hot water reservoir 128 is also provided, containing heating elements located either within or around the container. In certain embodiments, the hot water reservoir is in fluid communication with cold water reservoir 126 via tubing 124c, as illustrated. In other embodiments, the hot water reservoir 128 may be in fluid communication with pump 122 via tubing, such that fluid can flow to the hot water reservoir without flowing through the cold water reservoir. In other embodiments, not shown, the pump may be in fluid communication with a reservoir having no heating or cooling elements, such that the water within the reservoir remains at room temperature.

In the illustrated embodiment, the pump 122 is in electrical communication with float relay 132, which is further in electrical communication with float switch 134 positioned within cold water reservoir 126. The float switch 134 and float relay 132 can be used to control pump 122, causing pump 122 to turn on when the fluid level in the cold water reservoir 126 is below a desired level, attempting to pump water from the bottle 106 to the cold water reservoir 126. When the fluid level in the cold water reservoir 126 has reached a desired level, the pump 122 can be turned off. A similar sensor and control scheme may be employed for the hot water reservoir 128.

The pump 122 may be powered by power source 136, and may be electrically connected to control box 138, both of which may also power other components of the fluid dispenser 100 not shown here, such as heating or cooling elements. In one embodiment, power source 136 may comprise one or more batteries in electrical communication with pump 122. In other embodiments, the power source 136 may comprise a converter or other electrical components configured to permit the fluid in dispenser 100 to run on power supplied by an external source, e.g., 110 volt AC. In a further embodiment, a fluid dispenser may be configured to run on AC power but may also include a battery to provide power to the pump in the event that the external power source is unavailable, such as in the event of a power outage. In one embodiment, control box 138 may comprise various relay switches, electronic devices, rectifiers and a trickle charger.

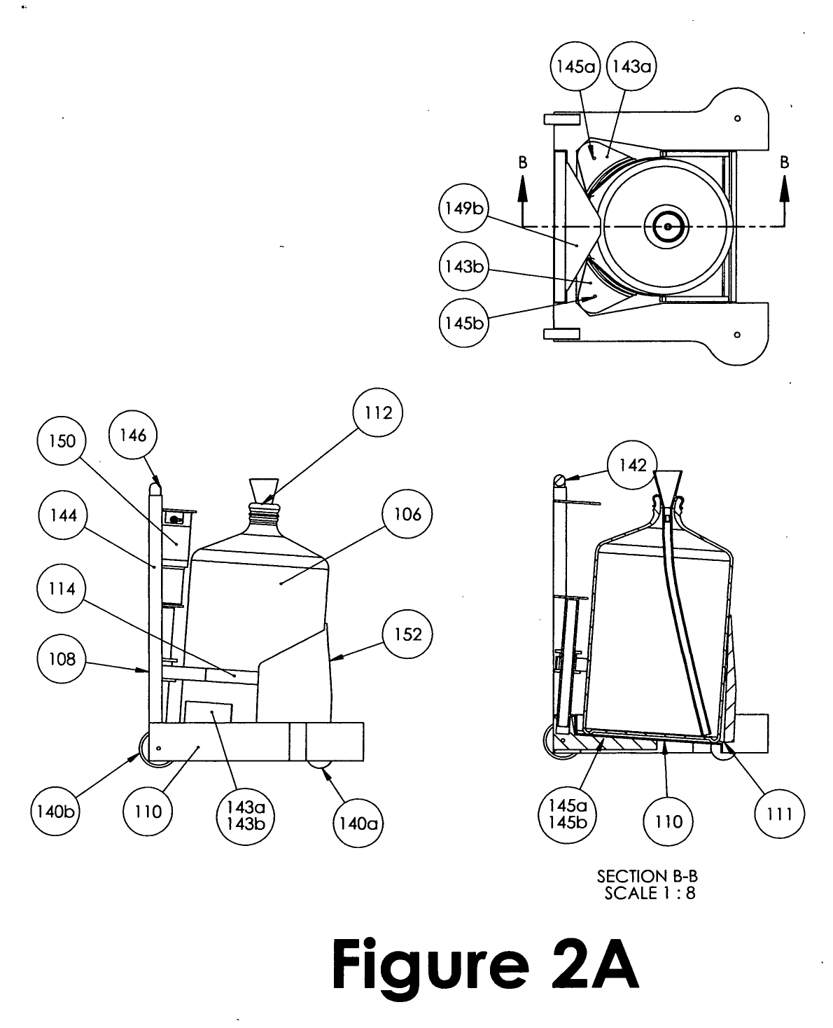

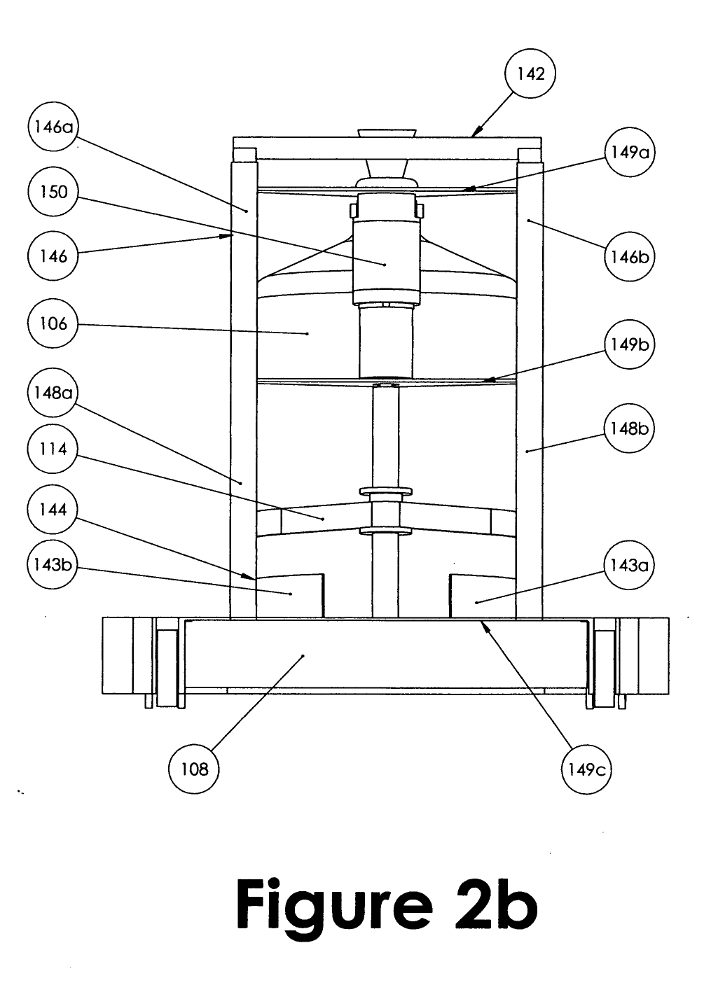

FIG. 2A illustrates a side view of an embodiment of a moveable cart 108 for use with a fluid dispenser 100, upon which bottle 106 is positioned. In the illustrated embodiment, moveable cart 108 comprises a platform 110 which is supported on two sets of wheels 140a, 140b. In one embodiment, wheels 140a located at the rear of the platform 110 are turnable with respect to platform 110, while wheels 140b located at the front of platform 110 have a fixed orientation with respect to the platform 110. Such an arrangement facilitates the movement of the cart 108 when being turned. As can be seen, the platform 110 is advantageously oriented at an angle, such that when the bottle 106 is positioned on top of platform 110 the upper surface of fluid contained within the bottle 106 is oriented at an angle to the upper surface of platform 110. This advantageously permits as much fluid as possible to be removed from the bottle 106. In further embodiments, in order to facilitate movement of the loaded cart, the moveable platform may comprise motorized wheels.

FIG. 2b illustrated a rear view of an embodiment of movable cart 108 for use with a fluid dispenser 100, upon which bottle 106 is positioned. In the illustrated embodiment, extending upward from the rear of platform 110 is handle 142 which can be used to maneuver the cart 108. In the illustrated embodiment, the handle 142 comprises a substantially vertical construct 144 which itself is comprised of two substantially vertical members, 148a, 148b which are joined in by three substantially horizontal members 149a, 149b, 149c. This handle 142, extends upwards from the platform surface 110, along with a telescoping upper portion 146a and 146b which permits handle 142 to be raised to a height more comfortable for moving cart 108, and also be lowered such that it can be positioned within the first chamber 102 of the fluid dispenser 100 (see FIG. 1). Thus, embodiments wherein the handle 142 comprises a telescoping upper portion 146 advantageously permit the expansion of the handle to a comfortable height during movement of the cart 108, while permitting the cart 108 to be stored in a smaller chamber within the fluid dispenser 100.

The front end of platform 110 comprises a ramp member 152 connected to the platform 110 such that the ramp member can be moved between a first position in which the free end of the ramp member 152 is not in contact with the ground. In the illustrated embodiment the ramp member 152 is coupled to the platform 110 via a ratcheted hinge 111. In the illustrated embodiment, it can be seen that the ramp member 152 may be rotatable such that the ramp member 152 can be placed in second position wherein the free end of the ramp member 152 rests against the bottle 106 supported by platform 110.

In the illustrated embodiment, the substantially vertical construct 144 also supports a gear box 150 which is mounted on the middle substantially horizontal member 149b. Gear box 150 is operably connected to the retention feature 114 extending around the bottle 106 and securing bottle 106 in place. In one embodiment, the retention FIG. 114 comprises a flexible member, such as a rope with an attached strap of broader lateral dimensions than the rope. In a further embodiment, the retention feature 114 may comprise a noose or noose like structure securable about the bottle 106. In another embodiment the retention feature 114 may be manually actuated via the gear box 150, such as through the use of a handle operably connected to the gear box. In such an embodiment, the retention feature 114 may be placed about the bottle 106 and manually actuated, e.g., to tighten the retention feature about the bottle 106, securing it in position on platform 110. In another embodiment, the retention feature may be actuable through the use of a motor or similar feature operably connected to gear box 150. Although the above discussion is generally directed to the use of a flexible member as a retention feature, it will be understood that in other embodiments, rigid components may form at least a part of the retention feature. For instance the retention feature may comprise one or more rigid components configured to contact and secure the bottle, such as a clamp or claw having rigid members which contact either side of the bottle.

Thus in a particular embodiment, a method of loading the platform 110 with a bottle 106 includes positioning the cart 108 adjacent to the bottle 106, and positioning the ramp member 152 in a first position, wherein the free end of the ramp member 152 is in contact with the ground near the bottle 106. The retention feature 114 may then be secured around the bottle 106. In certain embodiments, the retention feature is tightened about the bottle. The retention feature is then actuated via the gear box 150 to pull the retention feature 114 and the bottle 106 towards the gear box. The actuation may be either manual or automatic, such as via motor operably connected to gear box 150. This actuation pulls the bottle 106 up the ramp member 152. Thus the length of the ramp member 152 and the height of the platform 110 will affect the angle at which the bottle 106 is pulled up the ramp member 152. Thus, the length of the ramp member 152 and the height of the platform 110 can be selected such that a desired angle is obtained. In a particular embodiment the upper surface of platform 110 may comprise features configured to guide the bottle into a particular position on the platform 110, in order to ensure proper placement of the bottle 106 on the cart 108. In one particular embodiment, these features may include a raised members configured to form a V shape, horizontal member 143a and horizontal member 143b which can be positioned by moving along their axis of ratcheted hinges 145a and 145b so as to retain various sizes of standard water bottles in place, and in a further embodiment, the raised members 143a and 143b can be removable so as to permit the use of non-standard fluid containers.

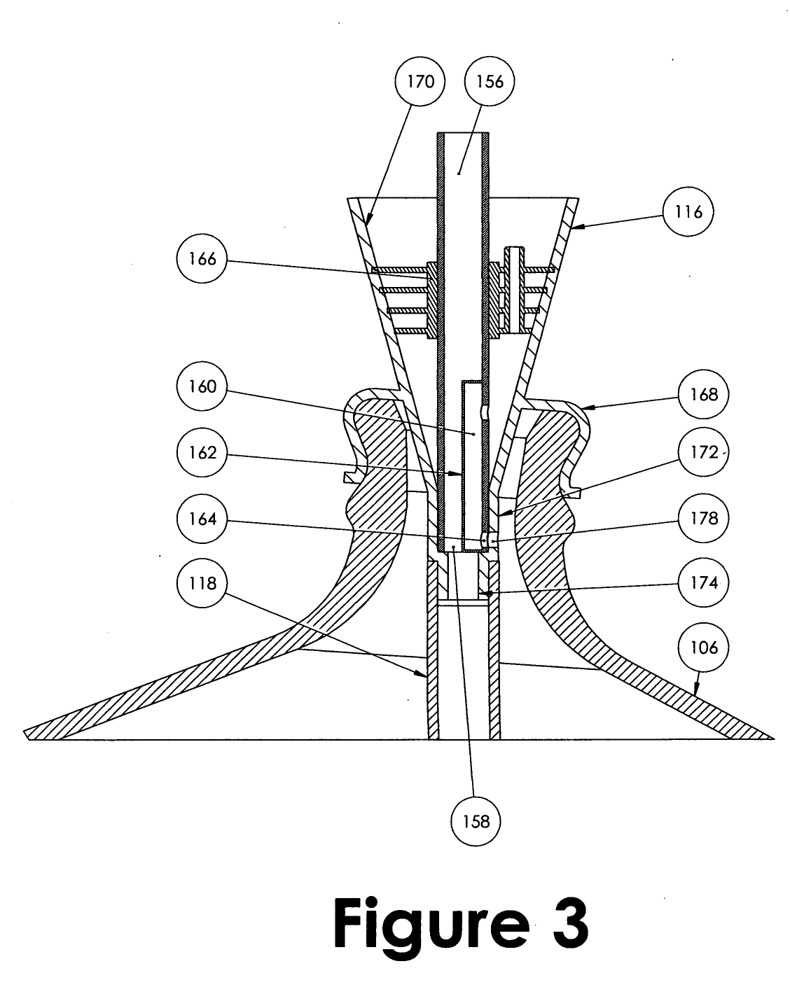

FIG. 3 illustrates in detail one embodiment of a funnel member 116 and a rod member 120 configured to engage funnel member 116 in order to provide fluid communication between the interior of bottle 106 and pump 122. In the illustrated embodiment, the rod member 120 comprises a first lumen 156 extending the length of the rod member 120 form a proximal upper end (not shown in FIG. 3) to a first aperture 158 located at the distal end of the rod member 120. A second lumen 160 extends from the upper end of a barrier 162 dividing the interior rod member 120 to a second aperture 164 located distal the upper end of the barrier 162. In the illustrated embodiment, the second aperture 164 extends through the sidewall of the rod member 120 near the distal end of the rod member 120. In a particular embodiment, the rod member may comprise a stainless steel pipe. A sealing member such as a rubber grommet 166 may extend about a portion of the rod member 120 in order to provide an airtight seal. In other embodiments, the sealing member may comprise a variety of other materials or components, but preferably comprise a resilient material so as to provide a tight seal.

Still with respect to FIG. 3, it can be seen that in the illustrated embodiment, the funnel member 116 is held in place at the top of the bottle by cap 168 which extends over the edges of the upper portion of bottle 106, and is configured to secure the funnel member 116 in place. It can also be seen that funnel member 116 comprises a substantially conical portion 170 whose inner surface is configured to accept and retain a sealing member, such as the rubber grommet 166. Funnel member 116 further comprises a substantially cylindrical portion 172 extending from the narrow end of conical portion 170, which comprises a lumen 174 configured to receive rod member 120 even when the rod member is slightly misaligned with respect to cylindrical portion 172. Tube member 118 extends downward from cylindrical portion 172, and is configured to reach the lowest portion of the bottle 106, as discussed with respect to FIG. 1.

It can also be seen that aperture 178 extending through a sidewall of cylindrical portion 172 is configured to align with aperture 164 extending through the sidewall of rod member 120, placing the second lumen 160 in fluid communication with the interior of bottle 106 when the funnel member 116 is placed in the opening of the bottle 106 and the rod member 120 engages the funnel member 116. Thus the second lumen 160 provides air return to the interior of the bottle 106 when water is pumped upward via tube member 118 and first lumen 156. Proper alignment of the apertures 164 and 178 can be provided through the placement of rubber grommet 166, which constrains translation of the rod member 120 with respect to funnel member 116 and the fabrication of an aperture 178 of sufficient dimension to ensure that there is some room for error in the alignment of the funnel member.

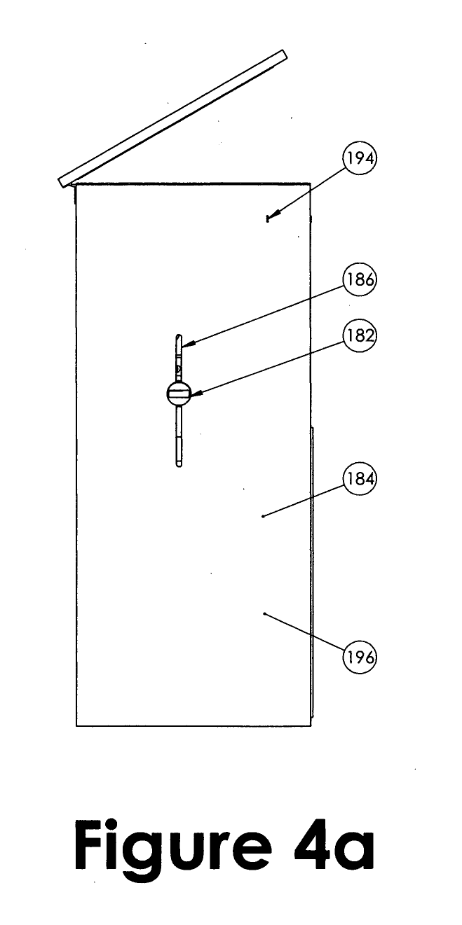

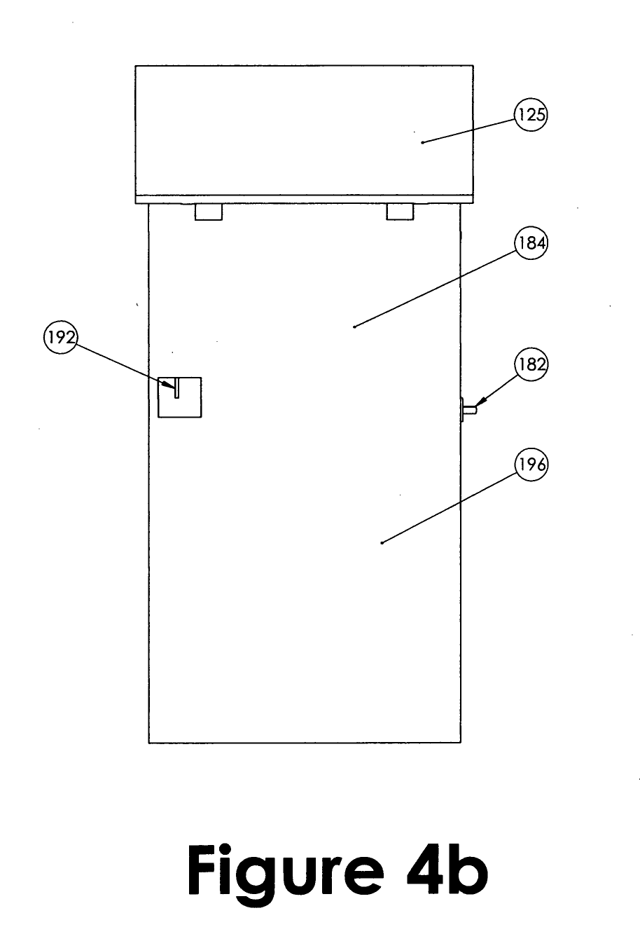

FIGS. 4A and 4B are exterior views of a fluid dispenser according to one embodiment of the invention. In FIG. 4A, it can be seen that the handle 182 extends from the side of fluid dispenser housing 184 and is actuatable along slot 186 extending vertically up the side of housing 184. Handle 182 is operably connected to rod member 120, and actuation of handle 182 between and upward position and a downward position moves the rod member 120 upward and downward, and causes the rod member to engage the funnel member 116.

It can also be seen in FIG. 4A that a dispensing component may include a drink mixer or dispenser, such as a coffee maker or a dispenser for providing drinks made from mixes such as lemonade. In the illustrated embodiment, the dispensing component is in fluid communication with the hot or cold water reservoirs 128 and 126, or directly with pump 122 in order to receive fluid from the fluid dispenser 100 and utilize that fluid in dispensing mixed or otherwise prepared drinks. In a particular embodiment, there may be a spigot on the front of housing 196 which is capable of being pulled out from the wall of housing 196 to enable fluid to be placed in a container external to the fluid dispenser 100. The end of the spigot may be in fluid communication with a hose member via a rigid or flexible shaft which when not extended from the unit is in a retracted position possibly coiled in a space within housing 196. In a particular embodiment, the fluid connection between the fluid dispenser 100 and the dispensing component 190 may be concealed between the two, both for aesthetic purposes and to provide protection for the connection from accidental dislodgement or other damage. In other embodiments, it will be understood that the dispensing component 190 need not be positioned on top of the fluid dispenser 100, as illustrated, but may be positioned to one side of fluid dispenser 100. In other embodiments, the components of the dispensing component 190 may be integrated into fluid dispenser 100 itself, such that the mixing or other preparation of drink may be performed within fluid dispenser 100.

Also in respect to FIG. 4A, the side of housing 184 contains a change bottle indicator light 194 and possibly a hot/cold display located on the front of fluid dispenser 100. This change bottle indicator light 194 is located on the side of the fluid dispenser 100 in the illustrated embodiment. In a particular embodiment this change bottle indicator light 194 may be located on the front of the housing 196. This change bottle indicator light is in electrical communication with power source 136 and in a particular embodiment may be in operable communication with pump 122 for the purpose of switching indicator light on in the event water in bottle 106 is depleated.

With respect to FIG. 4B, in an alternate embodiment, a fluid connection between dispenser and external device may be provided via fluid port 192 which in the illustrated embodiment is positioned on the rear fluid dispenser 100. The fluid port 192 may also be used to provide connections between the fluid dispenser 100 and external devices (not shown) such as a refrigerator, in order to provide a source of water for such external devices. For example in one embodiment, the fluid port 192 may be placed in fluid communication with a refrigerator via a length of tubing and may be used to provide a source of water for an ice dispenser within the refrigerator. Within the housing 196, the fluid in port 192 may be directly in fluid communication with the pump 122, or may be in fluid communication with one of the hot or cold reservoirs 126, 128.

In a particular embodiment, a method of placing pump 122 in fluid communication with a bottle 106 containing fluid is described. Funnel member 116, including tube member 118, is placed within the opening 112 on top of bottle 106. Tube member 118 is preferably positioned such that the lowest portion of the bottle is reached by the distal end tube member 118. Bottle 106 is positioned, such as by using movable cart 108, within first chamber 102 of fluid dispenser such that the opening 112 in the top of the bottle 106 is located along the axis of translation of rod member 120. Rod member 120 is actuated to a position, such as by actuating handle 182, in which the distal portion of rod member 120 engages the cylindrical portion 172 of the funnel member 116. The funnel member 116 is preferably positioned with respect to the rod member 120 such that aperture 178 extending through the sidewall of cylindrical portion 172 of funnel member 116 is aligned with aperture 164 extending through the sidewall of rod member 120.

The pump 122 may then be actuated, pulling fluid from a bottle 106 up the tube member 118 and to the pump 122 via the first lumen 156 of rod member 120, and further via the tubing 124a connecting the rod member 120 and pump 122. From there the fluid may be pushed directly to an outlet, such as dispenser or faucet, to an external device, such as fluid port 192, or to a reservoir such as cold water reservoir 126 or hot water reservoir 128

As can be seen in FIGS. 4A and 4B, due to the positioning of the bottle underneath the other components of the fluid dispenser, and the ease by which a moveable cart permits loading of bottles into the fluid dispenser, the fluid dispenser may be contained within a compact and aesthetically pleasing housing 196. The water bottle loaded need not be exposed as in many current bottled water dispensers, and the clearance required to load the bottles is significantly reduced as compared to bottled water dispensers wherein significant clearance is required to manually position the water bottles, in order to avoid injury.

In further embodiments, the housing 196 may comprise removable and replaceable panels such that the appearance of the fluid dispenser may be modified. In a particular embodiment, the housing 196 may comprise a frame to which ornamental panels can be affixed. In another embodiment, the housing 196 may form a component of a larger item. For example, the fluid dispenser may be built into a cabinet, sofa, bookshelf, desk, or any similar article.

Various modifications may be made to the embodiments. It is also recognized that, depending on the embodiment, the acts or events of any methods described herein can be performed in other sequences, may be added, merged or left out altogether (e.g., not all acts or events are necessary for the practice of the methods), unless the text specifically and clearly states otherwise. For example, one embodiment of a fluid dispenser may comprise a retention feature coupled to the interior of the fluid dispenser, rather than to a moveable cart, such that the bottle may be positioned adjacent to the fluid dispenser and pulled into the fluid dispenser via a retention feature secured around the bottle. In a further embodiment, the fluid dispenser may comprise a sloped platform upon which the bottle can be positioned.

While the above detailed description has shown, described and pointed out novel features of the invention as applied in various embodiments, it will be understood that various omissions, substitutions, and changes in the form and details of the device of process illustrated may be made by those skilled in the art without departing from the spirit of the invention. As will be recognized, this present invention may be embodied within a form that does not provide all of the features and benefits set forth herein, as some features and benefits set forth herein, as some features may be used or practiced separately from others.

What is claimed is:

1. An apparatus for dispensing water from a container, said apparatus comprising:
a moveable cart, configured to support a container, said moveable cart comprising:
a platform surface, wherein said platform surface is configured to support the container at an angle such that the bottom of the container is at an angle to the ground when in contact with the platform surface of said moveable cart for the primary purpose of aiding in the loading process of said container; and
a ramp member connected to an edge of the platform surface via a ratcheted hinge, said ramp member being rotatable about the ratcheted hinge from a first position in which an edge of the ramp member is in contact with the ground, to a second position in which an edge of the ramp member is supported by either the platform surface or a container located on said surface; and
two substantially vertical members extending upward from said platform surface and configured in such a manner that three substantially horizontal members connect the two substantially vertical members together at intervals extending upward from said platform surface for the purpose of providing structural stability; and
two additional vertical members extending upwards from substantially vertical members which contain said additional vertical members which telescope upward from said additional vertical members creating a telescoping handle on the top of said moveable platform for the purpose of steering the moveable platform; and
a flexible member configured to extend around at least a portion of the container; and
a gear box supported by said middle horizontal member and operably connected to the flexible member, wherein said gear box is configured to pull said flexible member towards said gear box and said gear box is either manually actuatable or actuatable via a d/c electric motor powered by batteries.
a cabinet in which the moveable platform shall be placed for the purpose of dispensing water.

2. The apparatus of claim 1, additionally comprising:
a funnel member configured to be placed in an aperture located in an upper surface of a container; and
a rod member translatable along the axis of the rod member between a first position in which there rod member is separated from the funnel member, and a second position in which a distal end of the rod member engages in the funnel member; and
a first lumen extending the length of the rod member, the first lumen comprising a first end located at the distal end of the rod member, and second end located at the proximal end of the rod member, and a second lumen comprising a first end located at an aperture in the side of the rod member near the distal end of the rod member and a second end in fluid communication with a portion of the first lumen; and
a conical rubber stopper being connected to the rod member by surrounding the rod member beginning at the distal end of the aperture located in the side of the rod member. The conical rubber stopper being connected to the rod member by surrounding the rod member will, when rod member is in the first position, be located in a position above the funnel member and when the rod member is in the second position the conical rubber stopper will be inserted into the funnel member forming a seal.

3. The apparatus of claim 2, wherein the rod member comprises
a first lumen extending the length of the rod member, said lumen comprising a first end located at the distal end of the rod member, and said end located at the proximal end of the rod member, and a second lumen comprising a first end located at an aperture in the side of the rod member near the distal end of the rod member and a second end in fluid communication with a portion of said lumen.

4. The apparatus of claim 2, wherein the funnel member comprises:
a hollow conical portion; and
a substantially cylindrical portion comprising a luminal area configured to receive said rod member.

5. The apparatus of claim 1, wherein the flexible member comprises;
a loop of flexible material with a strap of broader lateral dimensions than said loop of flexible material for the purpose of providing stability to the container after said loop of flexible material is affixed thereon.

6. The apparatus of claim 1, wherein the moveable platform comprises:
four wheels, of which two wheels are attached on the bottom of the posterior portion of the moveable platform, said wheels being in a fixed position; and
two wheels are attached to the bottom of the anterior portion of the moveable platform, said wheels being capable of swivel motion in order to aid steering of the moveable platform.

7. The apparatus of claim 1 wherein the gearbox is manually actuatable either by means of a manual crank mechanism or by means of a d/c electric motor powered by batteries.

8. The apparatus of claim 1 additionally comprising a dispensing component wherein said dispensing component can be placed in fluid communication with said pump.

9. The apparatus of claim 8 wherein the dispensing component is for dispensing water from a container said apparatus comprising;
a rod member comprising:
a first lumen extending the length of the rod member, said first lumen comprising a first end located at the distal end of the rod member, and a second end located at the proximal end of the rod member; and
a second lumen comprising a first end located at an aperture in the side of the rod member near the distal end of the rod member, and a second end in fluid communication with a portion of the first lumen;
a funnel member configured to be placed in an aperture located in an upper surface of a container, wherein said funnel member is configured to receive the distal end of said rod member, said funnel member comprising:
a hollow conical portion having outer diameter at the widest point of the conical portion which is larger than the diameter of the aperture;
a substantially cylindrical portion extending from the narrower end of the conical portion, said substantially cylindrical portion comprising a luminal area configured to receive the rod member; and
a flexible tube in fluid communication with the luminal area of the substantially cylindrical portion, wherein said flexible tube is configured to reach substantially the lowest portion of the container.

10. The apparatus of claim 9, wherein the substantially cylindrical portion of the funnel member comprises an aperture extending through the side of the substantially cylindrical portion and in fluid communication with the luminal area of the substantially cylindrical portion, and wherein the first end of the second lumen can be placed in fluid communication with said aperture when the rod member engages the funnel member.

11. The apparatus of claim 9, wherein the funnel member additionally comprises a flexible tube in fluid communication with the luminal area of the substantially cylindrical portion of the funnel.

12. The apparatus of claim 9, the funnel member additionally comprising an aperture extending through the side of the substantially cylindrical portion and in fluid communication with the luminal area of the substantially cylindrical portion

13. The apparatus of claim 9, the rod member additionally comprising a retention feature extending about the rod member, the retention feature configured to form a seal between the rod member and the funnel member.

14. The apparatus of claim 13, wherein the retention feature comprises a rubber grommet or conical rubber stopper configured to form a seal with an interior surface of the hollow conical portion

15. The apparatus of claim 9 additionally comprising a fixed sleeve through which the rod member extends, wherein said fixed sleeve constrains movement of said rod member other than the translation along the axis of the rod member.

16. A method of preparing an apparatus to dispense water from a container, said method comprising:
Inserting a funnel member into an aperture in an upper surface of the container, the funnel member comprising a hollow conical portion, a substantially cylindrical portion extending from the narrow end of the conical portion and a flexible tube extending from the substantially cylindrical portion toward the base of the container;
securing a flexible member around at least a portion of the container; actuating a gear box to pull the flexible member toward the gear box, thereby pulling the container onto a movable platform to which the gear box and the flexible member are operably connected, the movable platform including a ramp member extending downward at an angle from the edge of the first surface, the first surface configured to support the container such that the bottom of the container is oriented at an angle to the ground when in contact with the first surface of said moveable platform for the purpose of aiding in the loading process of said container; and
translating a rod member along the axis of the rod member to engage the distal end of the rod member with the funnel member, such that the proximal end of the rod member is in fluid communication with the distal end of the flexible tube.

17. The method of claim 16, wherein:
a substantially cylindrical portion of the funnel member comprises an aperture extending through the side of the cylindrical portion; and
the rod member comprises a first lumen extending from the proximal end of the rod member to the distal end of the rod member, and a second lumen extending from a first end located at an aperture in the side of the rod member near the distal end of the rod member and a second end in fluid communication with a portion of said first lumen; and
engaging the distal end of the rod member with the funnel member comprises aligning the aperture in the cylindrical portion of the funnel member with the aperture in the side of the rod member for the purpose of allowing air to egress thereby preventing the creation of a vacuum.

18. The apparatus of claim 1 additionally comprising:
means for positioning said container, wherein said positioning means are configured to support the container such that bottom of the container is oriented at an angle to the ground when in contact with the platform surface of a moveable platform the upper surface of the fluid is oriented at an angle to the ground for the purpose of aiding in the loading process of said container;
means for securing the container to the positioning means;
means for loading said container onto said positioning means wherein said loading means are configured to translate the securing means onto said positioning means; and
means for dispensing fluid from the container, wherein said dispensing means simultaneously permit the influx of air into the container as fluid is dispensed.

19. The apparatus of claim 18, wherein the positioning means comprises;
a fluid dispenser comprised of
a substantially vertical cabinet which is bisected laterally forming in the lower two-thirds of the fluid dispenser a first chamber with the top third of the fluid dispenser being a second chamber for the purpose of supporting dispensing means; and
said cabinet comprising a door on the front of said cabinet said door extending vertically from the base of said cabinet to the bottom of said lateral bisection; and
door of said cabinet opens manually to allow moveable platform apparatus to be rolled into the bottom chamber of the fluid dispenser; and
two horizontal rails opposing each other on the base of the interior of the fluid dispenser and aligned in such a manner as to receive the wheels of the moveable platform apparatus; and
a narrow vertical aperture placed in wall of fluid dispenser side extending from a mid location on side of fluid dispenser vertically to location of Internal lateral bisection; and
a lever located in such a way as to extend from exterior of fluid dispenser through the identified narrow vertical aperture to connect with interior rod member for the purpose of raising and lowering said interior rod member to engage or disengage rod member in fluid communication with funnel member; and
a chilled water holding tank; and
a spigot extending from the exterior of the upper portion of front of fluid dispenser to interior of fluid dispenser, said upper portion of front of fluid dispenser being directly above door; and
a flexible tube extending from distal end of spigot in interior of fluid dispenser to aperture in chilled water tank for the purpose of dispensing said cold water; and
a hot water holding tank; and
a second spigot extending from the exterior of the upper portion of front of fluid dispenser to interior of fluid dispenser, said exterior upper portion being directly above door; and
a flexible tube extending from distal end of said spigot in interior of said cabinet to aperture in hot water tank for the purpose of dispensing said hot water; and
a change bottle indicator located on the front upper corner of fluid dispenser; and
an aperture in side of fluid dispenser through which a/c power will be run via an electrical conduit.

20. The apparatus of claim 19, wherein the wherein the dispensing means comprises
a rod member being in fluid communication with the funnel member of claim 10; and
a horizontal plate with an aperture in the center through which the rod member is actuated; and
a breather valve connected to the top of said rod member for the purpose of allowing air to be vented and to prevent a vacuum as the dispensing mechanism is actuated; and
a flexible tube connected to the breather valve; and
a pump connected to said flexible tube for the purpose of dispensing water; and
a flexible tube connected at the upper portion of said fluid pump; and
a chilled water holding tank connected to said pump by said flexible tube for the purpose of holding water prior to the dispensing of water; and
a hot water holding tank wherein said hot water holding tank is connected by means of a flexible tube to chilled water holding tank for the purpose of receiving and heating water prior to the dispensing water of;

21. The apparatus of claim 19, wherein the chilled water holding tank additionally comprises;
a container for storing and chilling of chilled water; and
a float switch for the purpose of maintaining an established level of water in the chilled water holding tank, and additionally for the purpose of actuating the switch mechanism to operate pump for the purpose of filling tank with water from the container of origin, said container being that which has been identified as the container positioned on moveable platform; and
an aperture located at a position in said chilled water holding tank for the purpose of receiving a flexible tube, said aperture being below said float switch for the purpose of recirculation of chilled potable fluid back through the entire dispensing mechanism to the container of origin for the purpose of maintaining freshness of said chilled water throughout the dispensing mechanism; and
a refrigeration means; and
an aperture in the bottom of said tank for the purpose of dispensing fluid to the hot potable fluid holding tank; and
an aperture in the side of said cold potable fluid holding tank for the purpose of dispensing fluid to the exterior of the cabinet via a spigot.

22. The apparatus of claim 19, wherein the hot water holding tank additionally comprises;
a holding tank for hot water; and
a heating element for heating water; and
an aperture in the top of said holding tank for the purpose of receiving water from the chilled water tank; and
an aperture in the side of said holding tank for the purpose of dispensing hot water to the exterior of the fluid dispenser via a spigot.

23. The apparatus of claim 19 wherein the dispensing mechanism also comprises;
a control box; said control box being operably connected to pump and
an a/c power inlet, said a/c power inlet being connected via electrical conduit to exterior of fluid dispenser and on interior of fluid dispenser being operably connected via electrical conduit to pump; and
a back-up battery supply, said back-up power supply is operably connected to said pump via electrical conduit, and is operably connected to said ac power inlet, and Is operably connected to said control box.

25. The apparatus of claim 24 wherein the control box comprises
a timer for the purpose of activating change bottle indicator. The change bottle indicator is located on the exterior of fluid dispenser; and
a trickle charger for the purpose of providing additional charge to batteries from ac conduit; and
a rectifier for the purpose of changing a/c to d/c for the pump to be able to activate; and
a relay switch for the purpose of actuating the temperature control of the refrigeration means contained in chilled potable fluid holding tank, said relay will supply a/c power to the refrigeration means; and
a relay switch for the purpose of actuating the temperature control of the heating element in the hot water holding tank, said relay will supply a/c power to the heating element; and
an additional relay for the purpose of actuating pump.
